(19) United States
(12) Patent Application Publication
(10) Pub. No.: US 2018/0077102 A1
(43) Pub. Date: Mar. 15, 2018

(54) System and Method for Managing Text Messages

(71) Applicant: Mobex, Inc., Tampa, FL (US)

(72) Inventors: John G Dalrymple, Clearwater, FL (US); Mugur A Roz, West Roxbury, MA (US)

(73) Assignee: Mobex, Inc., Tampa, FL (US)

(21) Appl. No.: 15/264,470

(22) Filed: Sep. 13, 2016

(51) Int. Cl. H04L 12/58

(52) U.S. Cl. CPC H04L 51/22; H04L 51/14; H04L 51/02

(57) ABSTRACT

A system and method for processing, managing and distributing inbound text messages of multiple clients, which includes a platform for managing, routing and delivering text messages inbound to the platform to a plurality of agents within a client having one or more groupings. The incoming text messages are analyzed and responsive texts are formulated and delivered, based upon the content of the incoming texts.

### BACKGROUND OF THE INVENTION

The present invention generally relates to a system and method for managing SMS text messages, as well as preferably other types of text messages.

As texting becomes ubiquitous, businesses need a better way to manage their communication with clients, prospects, and staff. Current texting applications are predominantly peer-to-peer (from one person to another). Further, most business texting programs are for sending outgoing text, with many of these focused on the sending of mass group texts solely for marketing purposes, and not offering an inbound business texting management system. Existing texting processes fail to utilize the full force of the business organization to allow it to efficiently interface with the outside world. What is needed is a more robust and flexible text messaging communication system, providing a SMS-text-centric business communications platform that offers many of the same features available in a voice PBX phone system. (“SMS” stands for “short message service” and is commonly referred to as a text message, although there are other types of text messages such as those handled by Facebook Messenger, WhatsApp, and other messaging programs. SMS allows the sending of a message of up to 160 characters to another device. Most cell phones support SMS-type text messages.) MMS (text messages including photos and/or video), as well as corresponding links, may also form part of the “text messages” of the present invention.

U.S. Patent Application Publication No. 2014/0380145, filed May 8, 2014, titled “System And Method For Transmitting And Receiving Media Messages,” assigned to Twilio, Inc., hereby incorporated by reference in its entirety, discloses a network used to deliver media (voice and text) and allows web development tools to control it. The software applications described here may be used in conjunction with the web development tools and network disclosed in the Twilio patent application, or with other providers of SMS-enabled numbers such as Bandwidth.com, Frontier, and OneReach.com, for example, to control the delivery of media messages as described here.

Accordingly, it would be advantageous to provide a method and system to allow a more robust and flexible text messaging communication, including an inbound business texting management system.

It would also be advantageous to provide such a system and method that can be used in conjunction with those web development tools, Web portals and networks as may be associated with a particular company/client.

It would further be advantageous to provide such a system and method that allows a client to customize various features of the system, and to update the database of such a system.

Additionally, it would be advantageous to provide a system that receives, manages and transmits various types of messages such as SMS text and Facebook Messenger at the same time.

It would also be advantageous to provide a system that allows multiple companies/clients to share a single text number.

### SUMMARY OF THE INVENTION

This summary is provided to introduce a selection of concepts in a simplified form that are further described below in the Detailed Description. This summary is not necessarily intended to identify the only key features of the claimed subject matter; nor should it be the only aid in determining the scope of the claimed subject matter.

The objects mentioned above, as well as other objects, are solved by the present invention, which overcomes disadvantages of prior text messaging communication systems and methods, while providing new advantages not previously associated with them.

In a preferred embodiment of the invention, a method is provided for processing, managing and distributing inbound text messages of multiple clients. A platform is provided for managing, routing and delivering text messages inbound to the platform to a plurality of agents within a client having one or more groupings. The platform is capable of: (a) analyzing an incoming text message (which may be directed to the client, and may or may not be directed to any specific agents of the client); (b) formulating and delivering a responsive text to the sender of the text message based on the content of the incoming text message (which may or may not confirm the identity of one or more agents of the client that the sender intends to contact); (c) receiving a text reply from the sender (which may confirm the identity of the one or more agents of the client that the sender intends to contact); and (d) routing a further text message, based on the text reply, to one or more destinations, which may but need not be part of the client, and which may advise the client. A routing action or text response may be formulated based upon input provided by the client, to one or more confirmed agents of the client, or which may advise that the identity of one or more of the agents of the client cannot be confirmed. Based upon input provided by the client, the platform may direct that a call be made. The further text message may be sent to a plurality of agents within a grouping of the client.

In a particularly preferred embodiment, inbound text messages may be routed to a first set of one or more locations during the normal business hours of the client, and routed to a second set of one or more locations outside of normal business hours of the client.

In an alternative embodiment, the platform may utilize natural language processing to formulate the responsive text, or the further text message. Also, the platform may include a database, or may be in communication with a database; in either event, the platform may be capable of searching the database in order to formulate either or both of the responsive text and the further text message. Preferably, the database may be updated based upon information in the text reply received from the sender and/or based upon information in text messages exchanged between the sender and the one or more confirmed agents of the client.

In a further embodiment, the platform may send: (a) a further text query to the sender in response to the text reply from the sender; and (b) a further text message, based on analysis of the text query, to one or more of the confirmed agents of the client.

In still another embodiment, the method may include the use of a routing module, which may receive information from the platform relating to the confirmed identity of the one or more agents of the client, thereby enabling the sender and the confirmed one or more agents to text message each other.

In an alternative embodiment, client agents may use a client web page to control features of the platform as relates to the client, or to update information on the platform as relates to the client. Client agents may also be given permission to access the platform for purposes of management configuration or data interrogation through one or more of the following: a Web portal; a software application.

A system for processing, managing and distributing inbound text messages of multiple clients also forms part of the present invention. A platform is provided for managing, routing and delivering text messages inbound to the platform to a plurality of agents within a client having one or more groupings. The platform may be configured to: (a) analyze an incoming text message; (b) formulate and deliver a responsive text to the sender of the text message based on the content of the incoming text message; (c) receive a text reply from the sender; and (d) route a further text message, based on the text reply, to one or more destinations. It may be preferable for the platform to interface with software running on a computer server of the client.

Preferably, the text messages comprise stateful objects of the platform.

It may also be preferable for the system to allow a plurality of clients to share a single text number or group of text numbers.

### Definition of Claim Terms

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

### Claim Definitions

“Natural language processing” means processing using computer algorithms based on machine learning for the purpose of understanding the intent of the incoming message and for creating a natural language response.

“SMS” means a text messaging service component of phone, Web or mobile communication systems that uses standardized protocols to allow fixed line or mobile phone devices to exchange short text messages.

“SMS-enabled number” means a phone number that will recognize and receive an SMS text message.

“Text message” means any electronic message that is sent using “text messaging” as defined below.

“Text messaging” or “texting” means the act of composing and sending electronic messages between two or more mobile phones, or between fixed devices such as computers or portable devices such as IPads and other portable computers, over a phone network. Text messaging can include messages sent using SMS, as well as MMS (multimedia messages and corresponding links containing images, videos and/or sound content, as well as ideograms known as emoji).

As non-limiting examples, and solely to better understand the claims, a “client” might be a company, an “agent” might be a company employee, and a “client grouping” might be the sales department within a company.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a schematic diagram showing the logical flow for one preferred embodiment of the system for processing inbound text messages of the present invention;

FIG. 2 is a schematic diagram showing the logical flow for a preferred embodiment of the “Time Conditions” destination application of the system of the present invention;

FIG. 3 is a schematic diagram showing the logical flow for a preferred embodiment of the “Auto Responder And Router” destination application of the system of the present invention;

FIG. 4 is a schematic diagram showing the logical flow for a preferred embodiment of the “Finder/Updater” destination application of the system of the present invention;

FIG. 5 is a schematic diagram showing the logical flow for a preferred embodiment of the “Text Groups” destination application of the system of the present invention;

FIG. 6 is a schematic diagram showing the logical flow for a preferred embodiment of the “Individual Agent” destination application of the system of the present invention;

FIG. 7 is a schematic diagram showing the logical flow for a preferred embodiment of the “Stock Responses” destination application of the system of the present invention; and

FIG. 8 is a schematic diagram showing a preferred embodiment of the architecture incorporating the Finder/Updater.

In the diagrams, the portion of the diagram below the term “TBX” is intended to show those processes and functions taking place within the TBX platform.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

The business communications platform of the present invention (termed “TBX™” here) is designed to allow a business to receive inbound SMS text messages, as well as possibly other different types of messages (such as from Facebook Messenger and other text messages) and then to apply various features. For example, any of the following features may be applied using appropriate software:
An Auto Responder And Router that answers the incoming text, discerns the meaning of the text, and responds to the message and/or-routes the message, based upon customer defined criteria. For example, a responsive text might read “Thank you for texting Mega Corp. For our Sales Department please text ‘ 1,’ for our Support Department please text ‘2,’ and for our Billing Department please text ‘3.’ At any time send ‘C’ and we will call you right back.”
Text Groups: A group of agents set to receive incoming messages, usually with a designated business function; for example, a text to “sales” would be sent simultaneously (or sequentially) to everyone in the Sales Department.
Time-Of-Day text routing: The timing of the incoming text is checked for pre-determined routing rules; for example an incoming text messages may be routed to one location during business hours and to another location after hours.
A Finder/Updater: That discerns within the text the company the text sender wishes to reach and updates the database with that information for future use.
   The business management may control the type and use of features via a web page. The product may be provided with a basic customer contact directory, which may be integrated with commercially available Customer Resource Management (CRM) software with an integration mechanism, such as sold by Salesforce.com and others, allowing customer agents to retrieve information about the sender of the incoming text. With either the contact directory or the CRM integration, the customer agent may also send outgoing text to individuals or groups such as the service team, or all customers. Text messages may be received into and sent from the system via API, SMPP, SIP, HTTP, HTTPS, JSON or SS7 link. The agents internal to the business may receive and send texts several different ways, including through a computer application, a web application, on their desk phone, or on their mobile phone. This may be provided both as a product (hardware and software) and/or as a Cloud-based service.

The features described above are now more fully described.

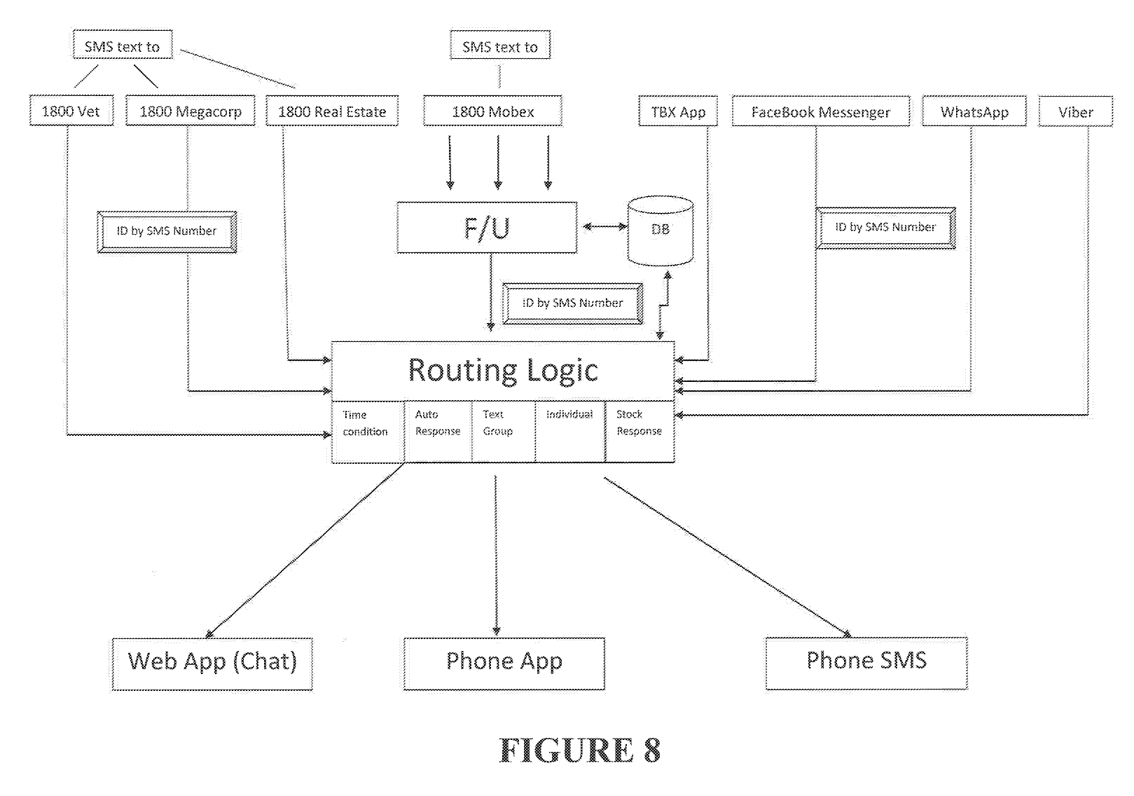

In one particularly preferred embodiment, a customer has a text-enabled number or a message account, such as Facebook Messenger; alternatively, the TBX platform of the present invention may be designed to interface with other message platforms such as WeChat or WhatsApp (see FIG. 8, for example). It is entirely possible, and advantageous. for a customer to have more than one type of messaging account; the TBX platform of the present invention is preferably designed to handle multiple of such concurrent accounts for the client.

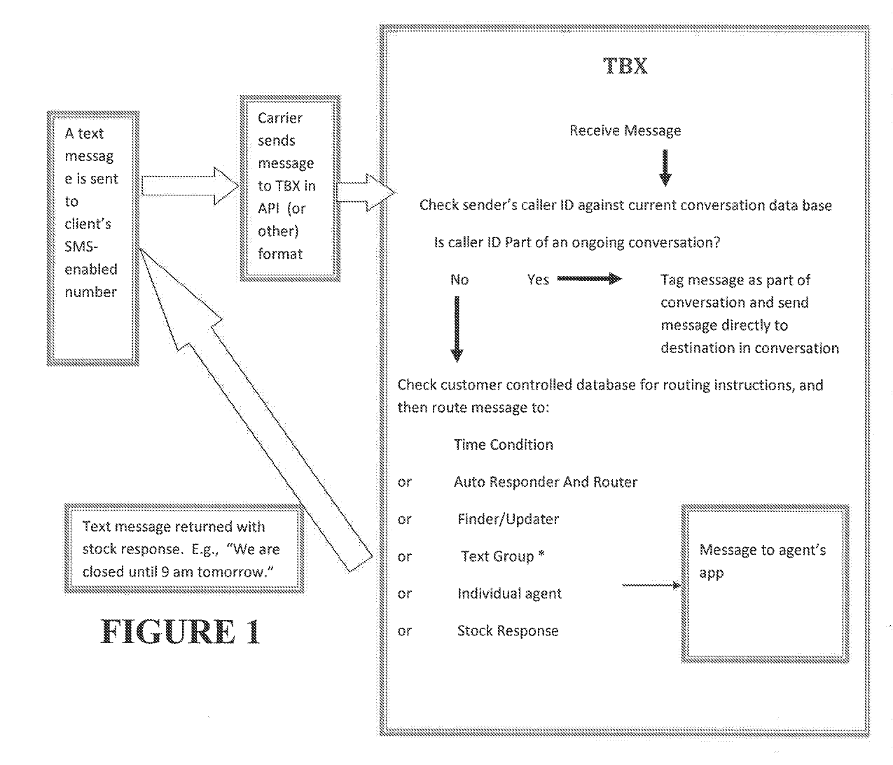

Software may be designed to allow the TBX platform to function as follows, in this example, and referring now to FIG. 1 as well:

1. RECEIVE: The message arrives from the carrier to the TBX platform via any one of numerous methods including API, SIP, SMPP, SS7, HTTP, HTTPS, JSON or others.
2. CHECK: Is this an initial (new) message or a message that is part of a conversation already assigned to an agent; the system will know based upon the caller ID number of the sender. If a message has already entered the system, a log entry is created with the caller ID and the ID of the agent that is involved.
3. ROUTE: The message is routed using a customer-preselected decision to send the message to one of the following destination applications. Note: In the conversation logic these destinations may be stacked in series, e.g.: First A, then B, then D. Or, they may be just one step, e.g. D.

### Exemplary Destination Applications:

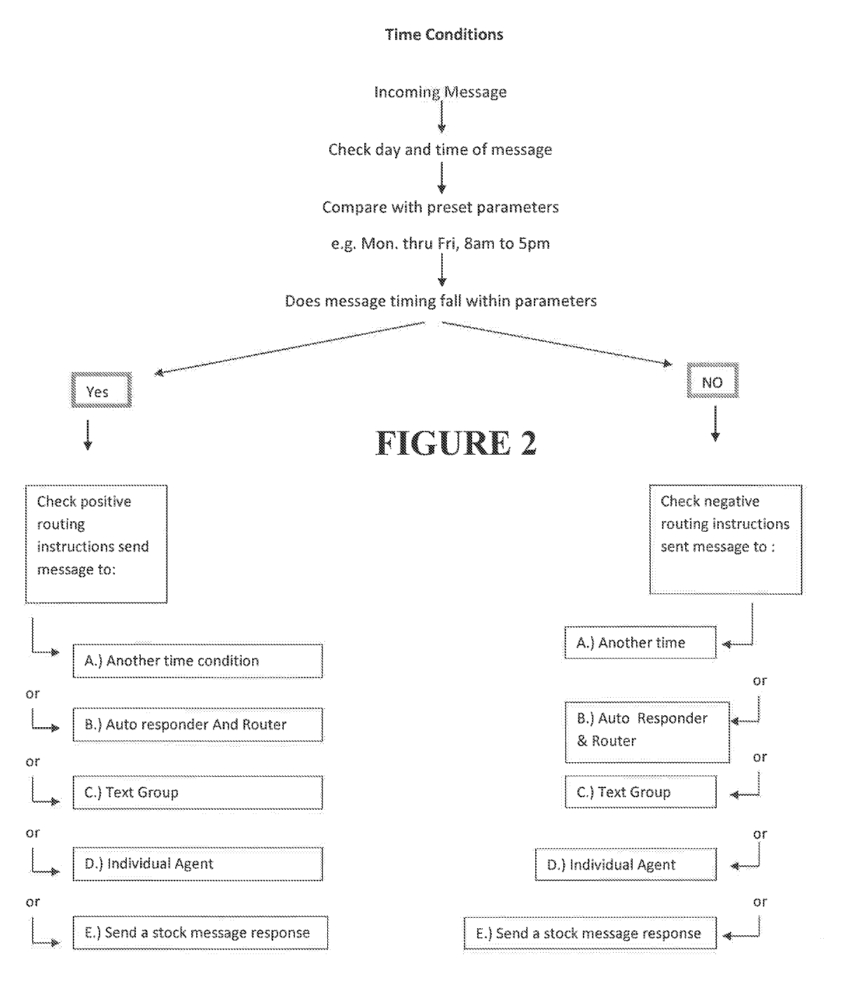

A—) Time Condition (see FIG. 2)

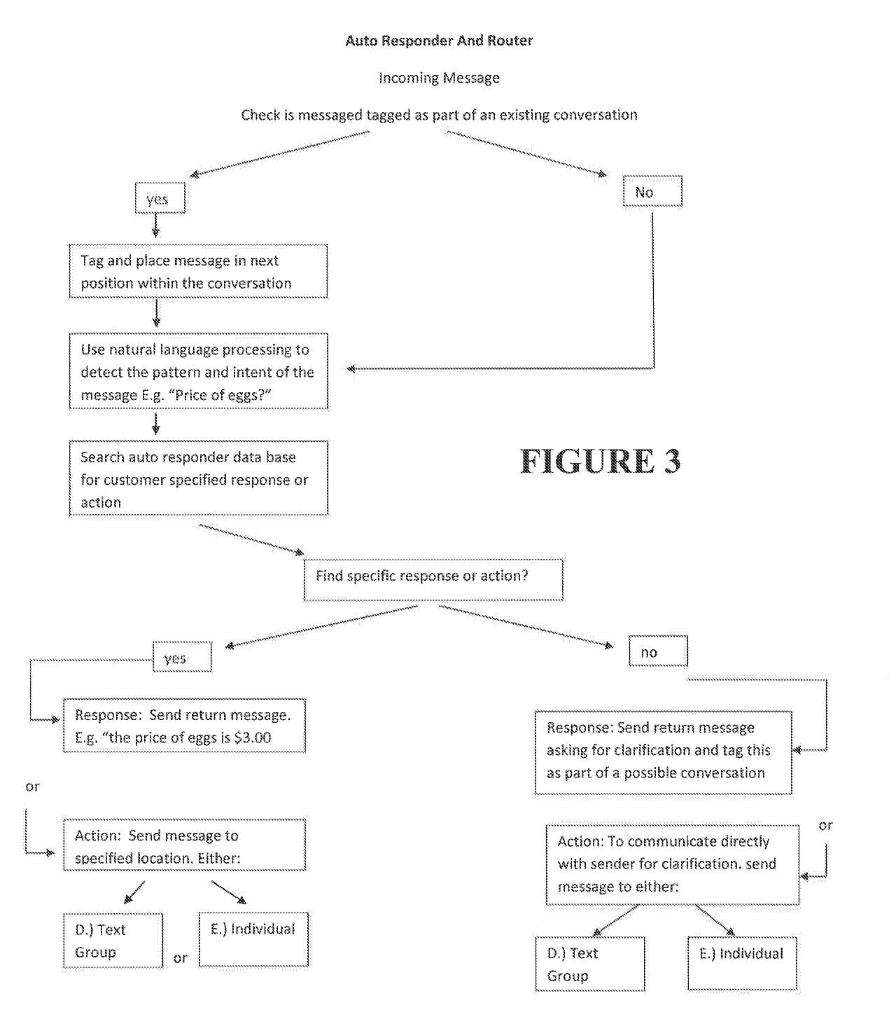

B—) Auto Responder And Router (see FIG. 3)

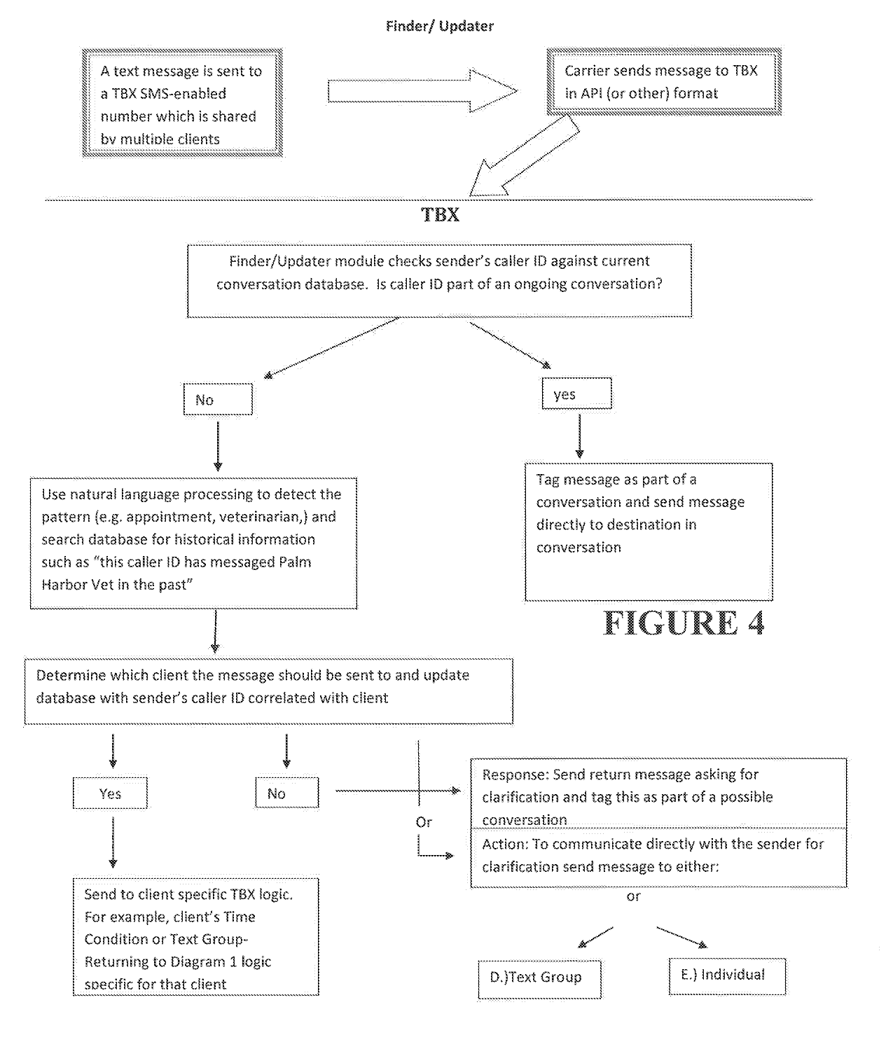

C—) Finder/Updater (see FIG. 4)

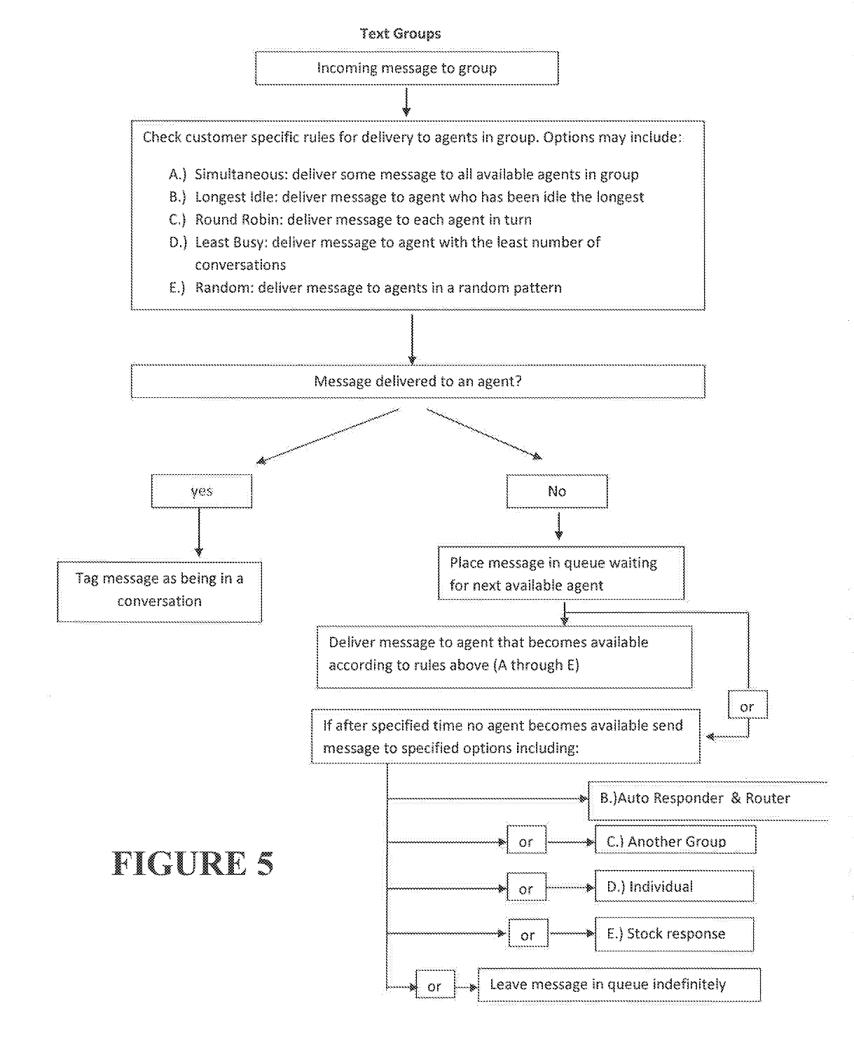

D—) Text Group (see FIG. 5)

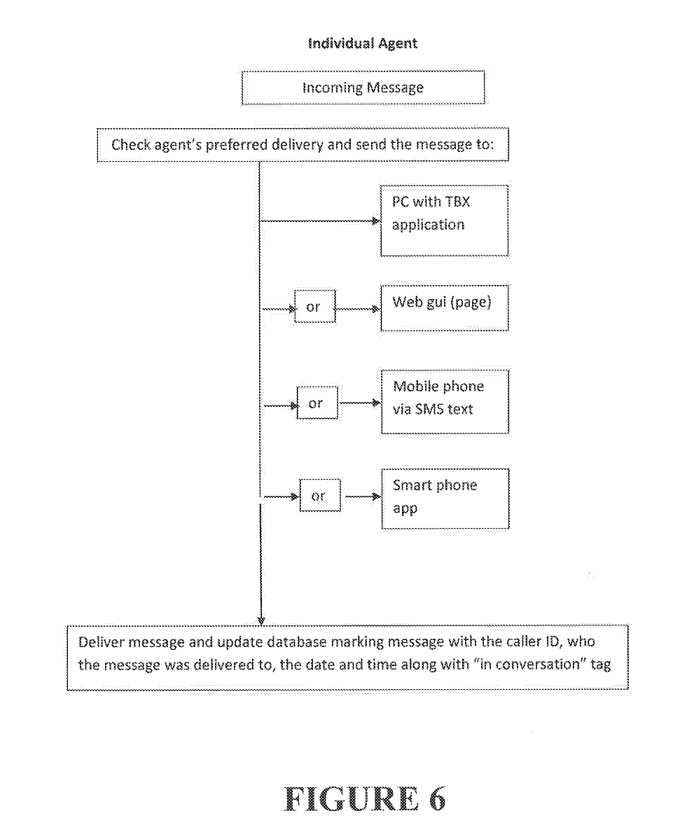

E—) Individual Agents (see FIG. 6)

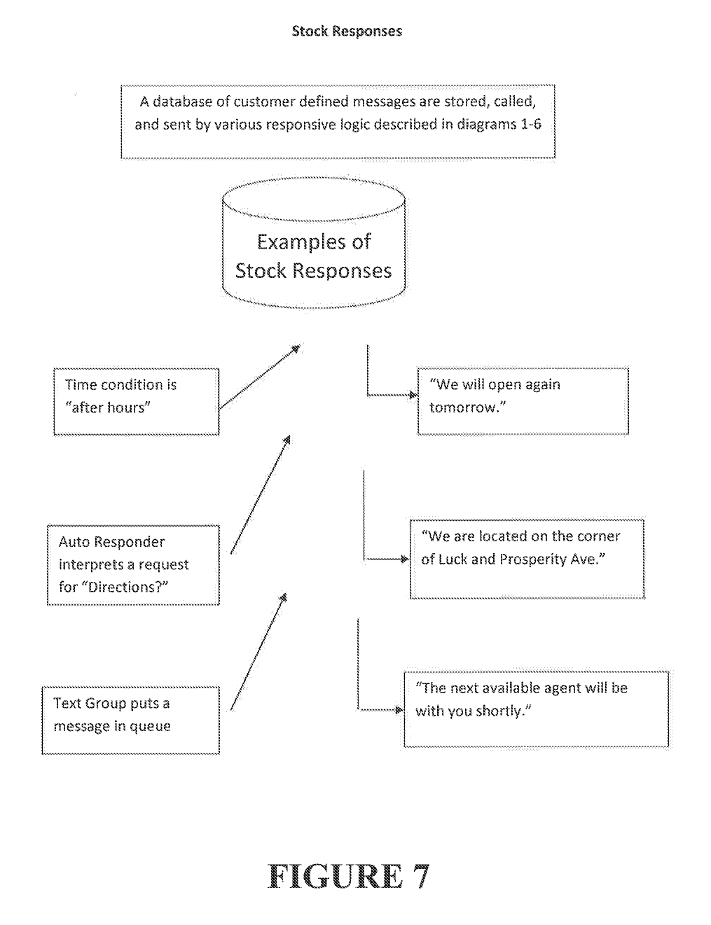

F—) Stock Responses (see FIG. 7)

Exemplary Destination Applications A-F are explained below:

### A—Time Condition:

Referring to FIG. 2, in this preferred embodiment a customer may pre-select from the following options, for example: (1) Day of week; or (2) Time of day; or (3) Holidays. Example: M-F, or Sam-5 pm.
CHECK: Is the message arriving at a time within parameters above:
If YES: ROUTE to customer preselected destination, such as:
A—Another time condition
B—Auto Responder And Router
C—Text Group
D—Individual

If NO—ROUTE to customer preselected destination (usually different than above), such as:
A—Another time condition
B—Auto Responder And Router
C—Text Group
D—Individual
E—Stock Response (“the office is closed today; we will be back and respond to your message tomorrow at 8:00 am”).

### B—Auto Responder And Router

Referring to FIG. 3, in this preferred embodiment the Auto Responder may “read” the inbound message, utilizing natural language processing, and searching for key words and phrases. If the message is understood, based on the match, either information is returned or the text message is routed to another destination. If there is no match, then a request for clarification of the message may be returned to the sender, or routed to a live agent. Following are examples of possible matches and corresponding actions or responses:

| Text Message Contains | Return Message or Action |
|---|---|
| “Location” “Address” | “We are located at . . . ” |
| “Hours” “Time” | “We are open M-F 9-5 . . . ” |
| “Appointment” | Message routed to Admin. Group |
| “Help” “Support” | Message routed to Support Group |
| “Billing” | Message routed to Billing Group |

Each Auto Responder's list of key words and phrases and corresponding replies and actions is preferably customer-specific. Over time, the system will learn to carry on more specific and detailed conversations with several conversational transactions. Here is an example of a multiple step Auto Responder And Router conversation:
Sender: “price of a Honda Accord”
Auto Responder: “new or used”
Sender: “new”
Auto Responder: “Which model, EX, LX or Sport?”

### Sender: “Sport”

Auto Responder: “depending on features we have several Sport models between $25 k and $30 k. May I connect you to a Sales Associate?”

### Sender: “Yes”

Action: sends the message (along with its history) to the Sales Group.

### C—Finder-Updater (F/U)

Referring to FIG. 4, in this preferred embodiment a user may text the TBX platform, but may not know the TBX text number of the company (customer) she wants to reach, and does not wish to search for it. The following may take place in this destination application:

1. The F/U module parses the SMS intelligently looking for keywords and patterns. For example, the user may send: “I need to set up an appointment with my vet.”

2. The F/U module uses natural language processing to detect the pattern (appointment, veterinarian) and may search the TBX database for historical information (if available).

3. If the user's veterinarian is found in the database, TBX may reply: “Are you still with Dr. Brown?” The user can update the information at this point. If the customer is not found, the TBX platform may reply: “Who is your veterinarian?”

4. Once the customer has been identified, the F/U module may pass that information to the routing module and the conversation can continue with the appropriate text group. The information in the TBX database may be updated as well (i.e., the user will be associated to her new veterinarian.)

5. If the customer cannot be found, the TBX platform may reply: “Sorry, this veterinarian is not yet a customer. You may give their office our number, 1 800 ______, so they can sign up.”

The purpose of the F/U module is thus two-fold: (1) it allows the TBX platform to identify the customer whom the user is trying to reach by using the customer's business name, or based on previous activities of the same user; and (2) the TBX platform database remains current as the F/U module requests record confirmation from the user.

### D—Text Group(s)

The customer assigns agents to certain groups. The customer may have multiple groups, e.g., Sales Group, Support Group, Admin. Group, etc. The customer preselects how an incoming message is delivered to agents within the group. For example:

Referring to FIG. 5, in this preferred embodiment any or each of the following may take place, as examples:

A—Simultaneous: A text message is sent to all group members. The first to accept the message is assigned the two-way communication with the sender of the text.

B—Longest idle agent: Delivers the message to the agent who has the greatest amount of time expired since the last message delivery.

C—Round robin: A text message is delivered to each agent in turn.

D—Lowest use: Agent with least number of conversations

E—Random: The system randomly chooses the agent who will receive the message.

If the message is not delivered and accepted immediately, the TBX platform decides, based upon client input, how long to keep message in queue and where to send if it falls out. Options might be: B/Auto Responder And Router; C/another group; D/Individual; or E/Stock Response.

### Group Text Flow Logic:

1) CHECK: Message Delivery Options

2) CHECK: Available Agents

3) ROUTE: Message to agent

4) ACTION: If no available agent, place in queue.

5) ACTION: Offer periodic message e.g. “your message will be handled by the next available agent.”

6) ACTION: Keep timer on messages in queue.

7) CHECK: Message time in queue and has it reached its time out.

8) ACTION: If yes, decide where to route the message. For example, route message to an Individual Agent or send a Stock Response.

### D—Individual: Agent or User

Referring to FIG. 6, in this preferred embodiment, a single destination for the message may be provided. It is anticipated most agents will use a desktop (computer) application which they may turn on and off, sign in and out, and declare as available or not. In actuality, any device that can send and receive messages may be used. For example, a Real Estate office might use the following example:

An incoming message, during business hours and identified by the Auto Responder And Router as relating to sales, may be sent to all sales agents in the field as a text message to their cell phones. The first to respond will establish a conversation with the sender.

### E/Stock Responses

Referring to FIG. 7, in this preferred embodiment preselected stock responses may be provided, which may constitute a series of predefined statements returned to the sender. They may be final with no anticipated conversation, e.g., “Our office is closed, please try again tomorrow.” Or they may be part of a logical conversation flow, e.g., “We anticipate an agent will be with you shortly.”

### EXAMPLES OF MESSAGE FLOW LOGIC INCORPORATING MULTIPLE APPLICATIONS

### Example 1—Time of Day, Auto Responder and Router, Text Group

Incoming Message to Mega Corp:

CHECK: New message or part of a conversation

### ANSWER: New

CHECK: Time of day and day of the week
ANSWER: During business hours
ACTION: Route message to Auto Responder to be read
CHECK: Recognize any keywords or phrases?
ANSWER: Yes, recognize “my bill”
ACTION: Route message to Billing Group

### CHECK: Billing Group Rules

Rule states to send to next available billing agent in group, check what agents are available and check last answered.
ACTION: Send message to the agent, the agent receives message along with sender's caller ID number which is also sent to Mega Corps. Billing system via API and the callers invoice history is made available to the billing agent.
ACTION: The agent responds “I have your billing information in front of me. How may I help?”
ACTION: A direct conversation is now established between the agent and the sender. All subsequent messages from sender will by-pass preceding logic and flow directly to this particular agent.

### Example 2—Time of Day, Auto Responder and Router, Text Group

Initial Message:

CHECK: Incoming message, “New” or “Existing Conversation”

### ANSWER: “New”

### CHECK: Time of Day (TOD)

ANSWER: After hours
ACTION: Route to after-hours Auto Responder.
ANSWER: Auto Responder replies: “Our hours are . . . I can provide you with our address and office hours or I can route your message to an agent first thing tomorrow morning, what would you like me to do?”

Next Message:

### CHECK: “New” or “Conversation

ANSWER: Part of above conversation
ACTION: Route to Auto Responder along with conversation information. Auto Responder reads message and recognizes key words “help”. Auto Responder responds “your message is received and will be sent to our customer service department tomorrow morning.”
ACTION: Send message to Customer Service Group queue.

### Example 3—Multiple Customers on the Same Number—Finder/Updater

In addition to customers having their own number, one number in a market may be offered that may be shared by multiple customers. This may be provided for simplicity for the user. For example, an individual might want one number to reach the Doctor, the Dentist, the Vet., etc. In this event, a new message would immediately enter the Finder-Updater destination application, which would be set to look for a keyword or phrase that would match a customer, e.g. Palm Harbor Vet. The message would then be routed according to the Vets' preferences.

Clients may have web portal and/or computer applications to allow them to make changes at any time. For example, an update from Dr. Brown to Dr. Smith, or to change time-of-day routing from 8-5 to 9-5, or to update where text messages go after-hours, etc. Thus, a client can change what is on the platform database, as relates to its company. Hierarchies can also be provided within the client, as well. This would allow certain company changes to only be made by those with administrative authority as designated by the company, for example, while other company agents might have a lower, view-only authority.

It will be understood that while in the preferred embodiment, the platform is integrated in the sense that it manages text message flow and analysis, as well as functioning as a database for recall and analysis of same, in other embodiments one platform may be used to manage text message flow while another separate but communicating platform/database may be used for data storage.

The TBX Platform could be offered either as a service or as a product. Smaller companies (e.g., dental firms and law firms) might purchase this as a service; larger companies might purchase the TBX platform as a product, and obtain a one-time license of the software so they could “own” system. A large company, for example, might choose to purchase the TBX Platform for a one-time fee and never have to pay for it again, and more easily make changes to the platform. Conversely, rental of service can be ongoing. The TBX Platform utilized to provide a service would be the same platform as that sold as a product, except with the added functionality of being multi-tenant (multiple customers on same box).

### Start/Stop Conversation

In order to divide SMS threads between the same endpoints into “conversations,” there will be criteria that the system utilizes in order to classify a new incoming text message as part of an ongoing conversation, or as part of a new conversation. In general, an incoming text message is part of a new conversation if there is no ongoing conversation between the same endpoints.

A conversation starts when an incoming message is routed to any one of the destinations described above and that destination, in turn responds to the message sender. At this point the conversation is marked as “started”. The message now becomes part of a stateful object within the database, with the originator's telephone number, start time, destination, and message(s) contained in a header record.

The system will mark a conversation as “ended” under two circumstances. The first one is a timeout parameter, configurable by the client (company) utilizing the system. For example, Megacorp can decide that if no text messages were exchanged between a customer and a service representative for more than two days, then the conversation is closed. Any other text message sent by the same customer will automatically start a new conversation, with a new conversation ID.

The second circumstance for ending a conversation is an “End Conversation” functionality (button, or other method) in the client interface. For example, a customer service representative logging into the system will be presented with an interface that includes a button for ending conversations. After she/he finishes helping the customer and the last text message that is part of the conversation is sent, the customer service representative clicks the “End Conversation” button. This marks the conversation as ended in the database, and any new message between that particular customer and the same customer services representative will trigger the creation of a new conversation, with a new conversation ID.

To summarize, start/stop is part of how a message becomes stateful within the invention. Thus, as opposed to a “stateless” protocol (i.e., one not requiring the server to retain session information or status about each communications partner for the duration of multiple requests), the present invention utilizes a “stateful” protocol which keeps the internal state on the server. It will now be understood that “stateful” is the foundation of a “conversation” and a stateful conversation has both a start time (obvious to obtain) and a stop time (as described above).

Overall routing logic for a preferred embodiment of the invention is shown in FIG. 8. At the top of the drawing, a texter/initiator is attempting to reach a customer via a toll-free or local telephone number, or through Facebook Messenger or otherwise through a text message. The message comes into the system through the finder/router, or directly into the routing logic if the finder/router is not needed (i.e., if the texter knows the customer number). Once the message enters the routing logic, rules established by the customer/client dictate where the message will be sent and how it will be treated (time condition, auto responder, text group, etc.). At this point, a check will be made to see whether the message is new or part of an existing conversation; if new, it will be routed per the customer rules; if existing, it will be routed to the internal endpoint of that conversation. Each of the logical conditions (time condition, auto responder, etc.) has, in turn, its own set of rules provided by the client/customer (as described above). The bottom of FIG. 8 represent the endpoints of the client/customer, i.e., the customer may have an application on its computer for purposes of chatting with the texter and/or may provide a phone application, or a phone SMS.

The above description is not intended to limit the meaning of the words used in the following claims that define the invention. Persons of ordinary skill in the art will understand that a variety of other designs still falling within the scope of the following claims may be envisioned and used. It is contemplated that these additional examples, as well as future modifications in structure, function, or result to that disclosed here, will exist that are not substantial changes to what is claimed here, and that all such insubstantial changes in what is claimed are intended to be covered by the claims.

We claim:

1. A method for processing, managing and distributing inbound text messages of multiple clients, comprising the steps of:
providing a platform for managing, routing and delivering text messages inbound to the platform to a plurality of agents within a client having one or more groupings, wherein the platform:
(a) analyzes an incoming text message;
(b) formulates and delivers a responsive text to the sender of the text message based on the content of the incoming text message;
(c) receives a text reply from the sender; and
(d) routes a further text message, based on the text reply, to one or more destinations.

2. The method of claim 1, wherein the one or more destinations are part of the client.

3. The method of claim 1, wherein the one or more destinations are not part of the client.

4. The method of claim 1, wherein the incoming text message is analyzed, and a routing action or text response is formulated, based upon input provided by the client.

5. The method of claim 4, wherein based upon input provided by the client, the platform directs that a call be made.

6. The method of claim 1, wherein the further text message is sent to a plurality of agents within a grouping of the client.

7. The method of claim 1, wherein inbound text messages are routed to a first set of one or more locations during the normal business hours of the client, and routed to a second set of one or more locations outside of normal business hours of the client.

8. A method for processing, managing and distributing inbound text messages, comprising the steps of:
providing a platform for managing, routing and delivering text messages inbound to the platform to a plurality of agents within a client having one or more groupings, wherein the platform:
(a) analyzes an incoming text message directed to the client but not to any specific agents of the client;
(b) formulates and delivers a responsive text to the sender of the text message based on the content of the incoming text message, to confirm the identity of one or more agents of the client that the sender intends to contact;
(c) receives a text reply from the sender confirming the identity of the one or more agents of the client that the sender intends to contact; and
(d) either routes a further text message, based on the text reply, to one or more of the confirmed agents of the client, or advises the client that the identity of one or more of the agents of the client cannot be confirmed.

9. The method of claim 8, wherein the platform utilizes natural language processing to formulate the responsive text.

10. The method of claim 8, wherein the platform utilizes natural language processing to formulate the further text message.

11. The method of claim 8, wherein the platform has a database, and wherein the platform searches its database in order to formulate either or both of the responsive text and the further text message.

12. The method of claim 11, wherein the platform database is updated based upon information in the text reply received from the sender.

13. The method of claim 8, further comprising the steps of the platform sending: (a) a further text query to the sender in response to the text reply from the sender; and (b) a further text message, based on analysis of the text query, to one or more of the confirmed agents of the client.

14. The method of claim 8, further comprising a routing module, wherein the routing module receives information from the platform relating to the confirmed identity of the one or more agents of the client, thereby enabling the sender and the confirmed one or more agents to text message each other.

15. The method of claim 14, wherein the platform database is updated based upon information in text messages exchanged between the sender and the one or more confirmed agents of the client.

16. The method of claim 1, wherein one or more agents of a client control features of the platform as relates to the client, or update information on the platform as relates to the client, 'via a client web page.

17. The method of claim 1, wherein one or more clients access the platform for purposes of management configuration or data interrogation through one or more of the following: a Web portal; a software application.

18. The method of claim 1, further comprising the step of allowing a plurality of clients to share a single text number.

19. A system for processing, managing and distributing inbound text messages of multiple clients, comprising:
a platform for managing, routing and delivering text messages inbound to the platform to a plurality of agents within a client having one or more groupings, wherein the platform:
(a) analyzes an incoming text message;
(b) formulates and delivers a responsive text to the sender of the text message based on the content of the incoming text message;
(c) receives a text reply from the sender; and
(d) routes a further text message, based on the text reply, to one or more destinations.

20. The system of claim 18, wherein the platform interfaces with software running on a computer server of the client.

21. The system of claim 18, wherein the text messages comprise stateful objects of the platform.
